(19) United States
(12) Patent Application Publication
(10) Pub. No.: US 2026/0072158 A1
(43) Pub. Date: Mar. 12, 2026

(54) METHOD FOR SECURE TIME OF ARRIVAL MEASUREMENT

(71) Applicant: Infineon Technologies Switzerland AG, Zurich (CH)

(72) Inventors: David Barras, Sierre (CH); Raghavasimhan Thirunarayanan, Oetwil Am See (CH); Boris Dimitrov Danev, Thalwil (CH)

(21) Appl. No.: 19/107,423

(22) PCT Filed: Aug. 7, 2023
(86) PCT No.: PCT/EP2023/071823

§ 371 Date: Feb. 27, 2025

(30) Foreign Application Priority Data
Aug. 31, 2022 (EP) 22193320.3

(51) Int. Cl. G01S 13/76

(52) U.S. Cl. CPC G01S 13/765

(57) ABSTRACT

A method for ultra-wideband (UWB) secure time-of-arrival (ToA), the method including: receiving at a receiving device a secure distance message from a transmitting device containing a UWB signal containing a secret distance pulse sequence; determining the ToA of a path of the secure distance message at the receiving device; determining time instants of the pulses of the expected secret distance pulse sequence of the path in the UWB signal based on the determined ToA of the path of the secure distance message; decoding from the UWB signal at the determined time instants of the respective UWB pulse values their respective bit values to determine a bit sequence received by the path of the secure distance message; and comparing the received bit sequence decoded from the UWB signal with the secret distance bit sequence provided to verify the authenticity of the transmitting device and the integrity of the ToA measurement.

### TECHNICAL FIELD

The present disclosure relates to the field of ultrawideband (UWB) secure time of arrival measurement and UWB secure distance measurement.

### BACKGROUND

UWB distance measurement is well known. A verifier V sends in an UWB channel a challenge message C1 with a distance pulse sequence N to a prover P which sends a response message R1 with a distance pulse sequence N in the UWB channel back to the verifier V as shown in FIG. 1. This distance pulse sequence N is used to detect the exact time of arrival of the challenge message C1 and the response message R1. Due to the verifier time difference DTv between sending the challenge message C1 and time of arrival of the response message R1, the time of flight of the two messages C1 and R1 can be determined and thus the distance between the verifier V and the prover P. Owing to the use of the UWB channel, the pulses of the distance pulse sequence N can be sent with very short duration of a length of 1-2 ns so that the time of arrival of distance pulse sequence N and thus of the messages C1 and R1 can be determined with a small error. The distance between the prover and verifier can be determined based on the verifier time difference DTv and a reply time of the prover P. The reply time of the prover P can be sent from the prover P to the verifier V (dual sided two way ranging) or can be fixed (single sided two way ranging). So, the quality of the distance measurement depends on the quality of the time of arrival measurement of the message R1 at the verifier V and for dual sided two way ranging on the quality of the time of arrival measurement of the message C1 at the prover P.

The time of arrival of the distance pulse sequence N at the receiver is normally determined by a cross-correlation between the theoretical/expected signal of the distance pulse sequence N (as transmitted) and the UWB signal as received at the receiver. The correct time of arrival is indicated by the peak of the cross-correlation, when the expected distance pulse sequence N corresponds to the distance pulse sequence N received at the receiver. However, for random distance pulse sequences N, the cross-correlation function will result in a high peak for the correct time of arrival and a plurality of small peaks (fake peaks) corresponding to some of the cross-correlation positions moved by multiples of the inter-pulse distance of the distance pulse sequence which coincidently do not average out. The fake peaks can have magnitudes well above the noise level and create fake early paths (as explained in more detail later in relation with FIG. 11). This is why for distance measurement, always distance pulse sequences N with special properties are used which theoretically remove fake peaks. The distance pulse sequence N uses normally the Ipatov code or Gold code which show these properties. For such special distance pulse sequences N, the cross-correlation does not show any fake peak so that each peak of the cross-correlation corresponds to a different true path of the message or the distance pulse sequence N. The same problematic appears for determining the CIR based on the preamble of the header of the message. This is why also the preamble (in UWB also called SYNC pattern) uses such special properties with e.g. Ipatov codes. Therefore, normally the preamble of UWB messages is used to measure the time of arrival of a message. This is why the distance pulse sequence used for time of arrival measurement is often also called preamble or preamble fragment.

To avoid that somebody fakes the distance by sending the known distance pulse sequence N from a non authenticated device, the messages C1 and R1 comprise a security pulse sequence SECv and SECp which are sent normally in a fixed time relationship with the distance pulse sequences N. The security pulse sequence SEC, sometimes also called ranging integrity fragment, is normally sequence of pulses with a random modulation (i.e. carrying random bits). For authenticating the transmitter V or P, the receiver P or V creates again a cross-correlation of the expected security pulse sequence SECv or SECp with the received UWB signal. The authenticity of the transmitter P or V or the integrity of the message C1, R1 is verified in the state of the art by two methods. Either the time of arrival determined by the cross-correlation of the security pulse sequence is compared with the time of arrival determined with the Preamble N and if the correspond, the transmitter V or P is approved. Alternatively, the time of arrival can also be determined just with the security pulse sequene SECV or SECp. Since an attacker does not know the security pulse sequence SECv or SECp, the distance measurement with such a security pulse sequence SECv or SECp is considered generally as secure.

However, the article of Singh et al “Security Analysis of IEEE 802.15.4z/HRP UWB Time-of-Flight” published in ACM WiSec 2021 shows attacks which actually can compromise the secure distance measurement and create fake shorter distances. Since the secure pulse sequence SECv or SECp is based on the cross-correlation of the complete secure pulse sequence SECv or SECp, one attack corrects the power of wrong guesses of the secure pulse sequence with a doubled power of the next guess until it hits the correct guess.

Even where the security pulse sequence SECp or SECv is decoded, standard data decoding techniques are used which use normally not the earliest path, but the strongest path or the complete channel impulse response (CIR) to decode the data. Also this allows to compromise the security of the distance measurement.

Another problem of the separate transmission of the distance pulse sequence N for the time of arrival measurement and the security pulse sequence SECp or SECv for the verification is that the UWB message which needs to be transmitted gets longer while the energy or TX budget which can be transmitted in the UWB message is limited for regulatory reasons. TX budget. This means that in a certain time, the transmitted energy of an UWB channel is limited. The energy corresponds to the average power of the UWB channel multiplied with or integrated over the time. More precisely, each 1 ms the energy of each UWB channel cannot exceed a maximum energy (also called the TX budget or transmit budget). Within this period of 1 ms, the energy can be freely distributed as long as it does not exceed the maximum energy. Shorter UWB messages requiring less UWB pulses can use pulses transmitted with a higher energy, while often longer UWB messages with a larger number of pulses can only be transmitted with a lower energy of the individual pulses. This makes it more difficult to receive such longer UWB messages as their pulses are hidden in the noise. Thus, UWB messages using the same TX budget having more pulses sent at a lower power make normally the reception of the UWB message harder for longer distances and noisy environments. A part of the TX budget is already taken by the header of the UWB message (including often the distance pulse sequence N or preamble used for time of arrival measurement). The remaining TX budget can be used for the security pulse sequence SEC. The longer the distance pulse sequence N is chosen, the more precise and more robust the time of arrival of the UWB message can be determined. The longer the security distance pulse sequence SEC is chosen, the higher is the security of the distance measurement. Thus, the length of the two pulse sequences in the UWB message is thus always a trade-off between robustness/time precision and security.

US2018/138993A1 discloses a secure time of arrival measurement in which the time of arrival is measured with a correlation with the synchronization pattern and validated by a correlation with a secret validation pattern. In one aspect, the time arrival is measured directly with a correlation with the secret validation pattern without the need of a synchronization pattern. In one aspect, the bit sequence transmitted in the secret validation pattern is demodulated to authenticate the transmitter device.

US2018/254925A1 discloses also a secure time of arrival measurement.

The LAN/MAN Standards committee of the IEEE computer society published the standard “P802.15.4z(TM)/D07 draft standard for Low-Rate Wireless Networks Amendment: Enhanced Ultra Wideband (UWB) Physical Layers (PHYs) and Associated Ranging Techniques” with information regarding error tolerance of decoded bit sequences for transmitter authentication.

### SUMMARY

It is the object of the disclosure to provide protocol for a secure UWB time of arrival measurement which avoids the problems of the state of the art, in particular which are safe against attacks.

According to the disclosure, this object is solved by the independent claims.

This object is solved by a method for UWB secure time of arrival measurement of a secure distance message transmitting in an UWB channel a distance pulse sequence corresponding to a secret distance bit sequence from a transmitting device to a receiving device, comprising the steps of: providing the secret distance bit sequence at the receiving device; determining at the receiving device an expected secrete distance pulse sequence corresponding to the secret distance bit sequence as expected to be received in the UWB channel, when receiving the secure distance message; receiving at the receiving device the secure distance message from the transmitting device, wherein the received secure distance message contains a UWB signal containing the secret distance pulse sequence corresponding to the secret distance bit sequence; determining the time of arrival of a path of the secure distance message at the receiving device based on the expected distance pulse sequence and the UWB signal containing the secret distance pulse sequence of the received secure distance message; determining the time instants of the pulses of the expected secret distance pulse sequence of the path in the UWB signal based on the determined time of arrival of the path of the secure distance message; decoding from the UWB signal at the determined time instants of the respective UWB pulse values their respective bit values to determine a bit sequence received by the path of the secure distance message; comparing the received bit sequence decoded from the UWB signal with the secret distance bit sequence provided to verify the authenticity of the transmitting device and the integrity of the time of arrival measurement.

This object is solved by a method for transmitting a secure distance message comprising the steps of: transmitting the secure distance message to a receiving device, wherein the secure distance message includes a secret distance pulse sequence used for distance measurement and authenticity verification, wherein at least the secret distance pulse sequence of the secure distance message is sent in a UWB channel.

This object is solved by a computer program comprising instructions configured, when executed on a processor, to perform one of the methods described above.

This object is solved by a receiving device for receiving a secure distance message from a transmitting device including a distance pulse sequence corresponding to a secret distance bit sequence, comprising a receiving means and a processing means; wherein the receiving means is configured for receiving the secure distance message from the transmitting device, wherein the received secure distance message contains a UWB signal containing the secret distance pulse sequence corresponding to the secret distance bit sequence; wherein the processing means is configured for: providing the secret distance bit sequence; determining an expected secret distance pulse sequence corresponding to the secret distance bit sequence as expected to be received in the UWB channel, when receiving the secure distance message; determining the time of arrival of a path of the secure distance message at the receiving means based on the expected distance pulse sequence and the UWB signal containing the secret distance pulse sequence of the received secure distance message; determining the time instants of the pulses of the expected secret distance pulse sequence of the path in the UWB signal based on the determined time of arrival of the path of the secure distance message; decoding from the UWB signal at the determined time instants of the respective UWB pulse values their respective bit values to determine a bit sequence received by the path of the secure distance message; comparing the received bit sequence decoded from the UWB signal with the secret distance bit sequence provided to verify the authenticity of the transmitting device and the integrity of the time of arrival measurement.

This object is solved by a transmitting device for transmitting a secure distance message to a receiving device, wherein the secure distance message includes a secret distance pulse sequence used for distance measurement and authenticity verification, wherein at least the secret distance pulse sequence of the secure distance message is sent in a UWB channel.

This object is further solved by a method for distance measurement between a verifier and prover comprising the following steps: sending a challenge message with a challenge pulse sequence from the verifier to the prover; sending a response message with a response pulse sequence from the prover to the verifier; determining securely the time of arrival of the response message at the verifier based on the method for secure time of arrival measurement; determining the distance between the verifier and the prover based on the verifier time difference between sending out the challenge message from the verifier and the determined time of arrival of the response message.

This object is further solved by a system for distance measurement comprising a verifier and a prover, wherein the verifier is configured to sending a challenge message with a challenge pulse sequence to the prover; wherein the prover is configured to sending a response message with a response pulse sequence to the verifier; wherein the verifier is configured to determining securely the time of arrival of the response message at the verifier based on the method for secure time of arrival measurement or wherein the verifier is a receiving device as described above determining a secure time of arrival of the response message; determining the distance between the verifier and the prover based on the verifier time difference between sending out the challenge message from the verifier and the determined time of arrival of the response message.

The idea of the aspects of the disclosure is to use the same secret distance pulse sequence for time of arrival measurement and for verifying the authenticity of the transmitting device and decoding the bit sequence at the time instant corresponding to the path determined as the time of arrival of the secure distance message to verify also the integrity of the time of arrival measurement. This allows a high security against any known attack. Instead of simply considering the cross-correlation of the secret distance pulse sequence to verify the authenticity of the transmitting device, the actual transmitted bit sequence is decoded from the UWB signal. However, the decoding on the UWB signal is done only at the time instant defined by the path that corresponds to the determined time of arrival. This guarantees a high security level against any method trying to guess the secret distance pulse sequence and manipulate the power of the individual pulses (based on the previous guesses). Thus, the integrity of the time of arrival measurement is also verified with this method and any manipulation of the time of arrival measurement is detected when decoding the bit sequence at the respective time instants of the path. Since the same secret distance pulse sequence is used for time of arrival measurement and for verifying the authenticity, the pulse sequence can be chosen longer so that the effect of fake paths can be reduced. Also, the robustness of the bit decoding is increased when the bit decoding related to one path is based on the same pulse sequence used also to determine the time of arrival, i.e. the path chosen for decoding. This decoding technique is also different from most known classic UWB decoding techniques which normally use the strongest path or the complete CIR for decoding and are thus not related to the path of the determined time of arrival. This opens the possibility of security attacks against the secure time of arrival measurement.

The dependent claims refer to advantageous aspects of the disclosure.

In one aspect, the step of comparing the received bit sequence decoded from the UWB signal with the secret distance bit sequence provided comprises to determine the number of errors of received bit sequence with respect to the secret distance bit sequence and consider a transmitter as verified, if the number of errors determined is below a threshold. The decoding of the bit sequence at the time instants of the path related to the determined time of arrival might increase the error rate of the decoded bit sequence. By accepting a certain error rate in the bit sequence decoded for verifying the authenticity of the transmitting device and the integrity of the time of arrival, the secure time of arrival measurement can also be performed in noisy environments.

In one aspect, at each time instant of the UWB signal determined, the bit of this time instant is decoded from a time window of the UWB signal around the time instant, wherein the time window is smaller than or equal to sixteen nanoseconds

In one aspect, the same pulses of the secret distance pulse sequence are used at the receiver once for detecting the time of arrival and once for decoding the bit values of the pulses.

In one aspect, the secret distance pulse sequence is transmitted in the UWB channel using a time hopping method with two or more different inter-pulse distances, preferably with more than two different inter-pulse distances.

The different inter-pulse distances reduce the amplitude fake paths when determining the time of arrival based on a combination (e.g. cross-correlation) of the expected distance pulse sequence and the UWB signal containing the secret distance pulse sequence of the received secure distance message and increases the quality of the time of arrival measurement to find the correct true earliest path of the secure distance message.

In one aspect, the time of arrival of the secure distance message at the receiving device is determined based on a cross-correlation between the expected secret distance pulse sequence and the received UWB signal.

In one aspect, an early path time window before the maximum value of the cross-correlation is determined, wherein a weaker early path is detected in the early path time window.

In one aspect, a mismatched distance pulse sequence is computed which varies some pulse values of the secret pulse sequence to minimize fake peaks in the cross-correlation in the early path time window, wherein the weak early path is determined based on the cross-correlation in the early path time window between the mismatched distance pulse sequence and the UWB signal received. This aspect allows to reduce the fake paths when determining the time of arrival based on the cross-correlation of the expected distance pulse sequence and the UWB signal containing the secret distance pulse sequence of the received secure distance message and increases the quality of the time of arrival measurement to find the correct true earliest path of the secure distance message.

In one aspect, the secret distance pulse sequence comprises combination of a known portion and secret portion, wherein the known portion corresponds to a special code which reduces or removes fake peaks. Due to the effect of the known special code pulses, the fake paths created by the secret portion are reduced.

In one aspect, each pulse of the secret distance pulse sequence has a first pulse value or a second pulse value, wherein the secret distance pulse sequence comprises known pulses and secret pulses, wherein a known pulse is a pulse whose pulse value is known, wherein a secret pulse is a pulse whose pulse value is secret, wherein the known pulses follow a special code which reduces or removes fake peaks, wherein the special code comprises a first code value corresponding to the first pulse value, a second code value corresponding to the second pulse value and a third code value corresponding to not sending out a pulse, wherein the secret pulses are sent at the position of at least some of the third code values in the special code. Preferably, the special code is a IPATOV code. Due to the effect of the known special code pulses, the fake paths created by the interleaved secret pulses are reduced.

The subsequent aspects allow to increase the TX budget available for the secret distance pulse sequence. An increased TX budget allows to send longer secret distance pulse sequences with more pulses which allow that the fake paths reduce in amplitude as they average out with higher numbers.

In one aspect, the secure distance message comprises a first information portion and a subsequent second information portion, wherein the second information portion contains the secure distance bit sequence, wherein the first information portion is used to detect the secure distance message in a received signal and/or to determine a clock offset between a system clock of the receiving device and a system clock of the transmitting device.

In one aspect, the secure distance message comprises a message frame in the physical layer with the first information portion transmitted in a narrowband channel and the second information portion transmitted after the second information portion in the UWB channel with a time relation between the first information portion and the second information portion defined by the message frame in the physical layer.

In one aspect, the secure distance message comprises a message frame in the physical layer with the first information portion transmitted in a first UWB frequency-time portion and the second information portion transmitted in at least one second UWB frequency-time portion, wherein each UWB frequency-time portion is defined as a portion of the UWB frequency-time domain limited by the TX budget of the UWB channel, wherein the first UWB frequency-time portion is different from the second UWB frequency-time portion.

In one aspect, the second information portion is sent after a minimum time after the start of the first information portion required to have again the full UWB TX budget in the UWB channel.

In one aspect, the expected time of arrival of the expected distance pulse sequence in the UWB channel with respect to the time of arrival of the first information portion is determined based on a message protocol of the secure distance message and based on the determined clock offset, wherein the time of arrival of the secure distance message at the receiving device is determined based on the expected distance pulse sequence and the UWB signal received at the expected time of arrival.

In one aspect, the second information portion is transmitted in the UWB channel without a message portion comprising a preamble, a start of frame delimiter and packet header.

In one aspect, the second information portion comprises a plurality of second information sub-portions transmitted in different UWB frequency-time portions, wherein each different UWB frequency-time portion is defined as a portion of the UWB frequency-time domain limited by the TX budget of the UWB channel, wherein the secret distance pulse sequence comprises a plurality of different secret distance pulse sub-sequences transmitted in the different second information sub-portions.

In one aspect, the secret distance pulse sequence comprises a plurality of different secret distance pulse sub-sequences transmitted in different UWB frequency-time portions of the UWB channel. Other aspects according to the present disclosure are mentioned in the appended claims, the subsequent description of

### BRIEF DESCRIPTION OF THE DRAWINGS

FIG. 1 is a schematic diagram illustrating an aspect of the prior art of secure distance measurement.

FIG. 2 is an illustration of a conventional frame in the physical layer for an UWB message or an NB message according to the prior art.

FIG. 3 shows an exemplary time order of a pulse sequence with equidistant pulses.

FIG. 4 shows an exemplary time order of a pulse sequence with bursts.

FIG. 5A is an illustration of a first example of the message frame in the physical layer for secure distance message according to the disclosure.

FIG. 5B is an illustration of a second example of the message frame in the physical layer for secure distance message according to the disclosure.

FIG. 6 is an illustration of the transmission of an exemplary message frame and its communication channel(s) between a transmitter and a receiver.

FIG. 7 is an illustration of a third example of the message frame in the physical layer for secure distance message according to the disclosure.

FIG. 8 is an illustration of a fourth example of the message frame in the physical layer for secure distance message according to the disclosure.

FIG. 9 is an illustration of a fifth example of the message frame in the physical layer for secure distance message according to the disclosure.

FIG. 10 describes an example of a method of measuring a secure time of arrival of a message.

FIG. 11 shows an aspect of a system, method, verifier and prover for secure distance measurement according to the disclosure.

FIG. 12 shows the problem of determining a cross-correlation of short random pulse sequences in multi-path environments.

FIG. 13 shows an improved aspect for reducing the problem with fake paths.

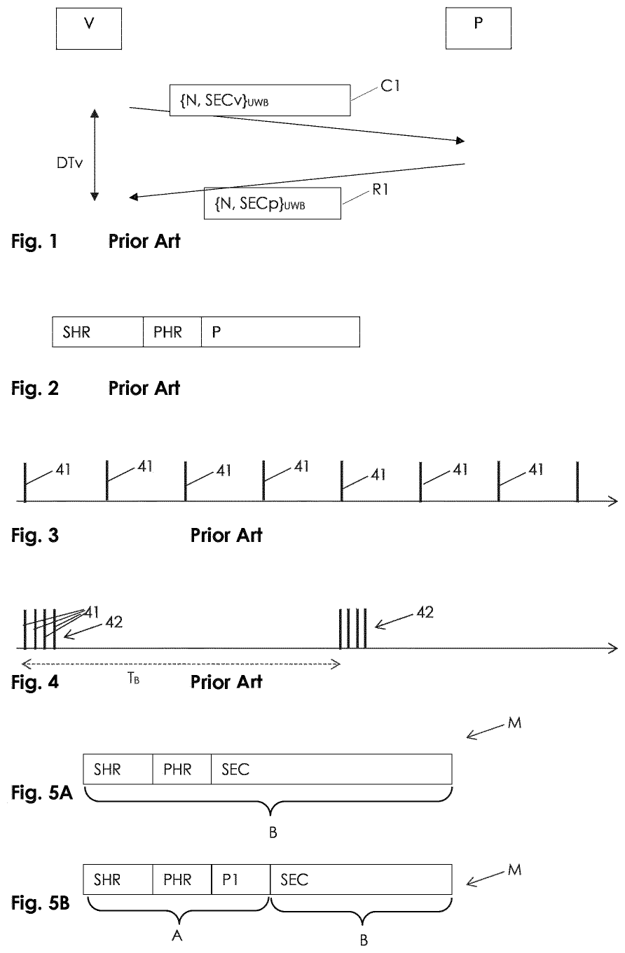

### DETAILED DESCRIPTION

Other characteristics and advantages of the present invention will be derived from the non-limitative following description, and by making reference to the drawings.

In the following some terms used in here are defined.

A message is a data unit in the physical layer of the OSI model. In other words, a message is a data unit transmitted over a communication channel, in this disclosure via a radio communication channel, wherein the data unit has a common organization. This organization of the message is called message frame or message protocol. The message comprises normally at the beginning some information allowing the detection of a message, the determination of the clock offset and/or the determination of the frequency offset, etc. The message contains normally further information regarding the sending device (origin) and the receiving device (destination) so that the receiver RX knows, if the message is indeed addressed to the receiver RX. Otherwise, it can ignore the message. Depending on the message protocol, the administration information is simpler or more complex. This administrational information holds for the complete data transmitted in the message. A new message comprises again the administrational information and is thus completely independent from the previous message. Two messages are independent from each other in relation to the data transmitted, but also in relation to the timing of the transmission. A new message requires a new synchronization on the new message. Traditionally, a message is transmitted in the same communication channel. In the present disclosure, there are some aspects in which the message is transmitted in two subsequent different communication channels as will be explained in more detail below.

A message frame is the definition of the arrangement of the data transmitted in the message (also called message protocol). The message protocol or frame is known. This means that the message protocol is fixed (always the same) or defined by parameters sent within the message itself. FIG. 2 shows an example definition of a message frame of a message in the physical layer. The message frame in the physical layer comprises a synchronization header SHR, a packet header PHR and a physical payload P. The synchronization header comprises a synchronization pattern which in NB is often called PREAMBLE and in UWB is often called SYNC. The terms PREAMBLE and SYNC are used interchangeable in here. After the synchronization pattern, the synchronization header SHR comprises often a start of frame delimiter SFD. The PHR comprises normally the length of the message so that the receiver RX will know, when the message/frame has ended. The physical payload comprises the transmitted data. The SHR and PHR are for the physical layer, i.e. for the receiving chip to identify a message in the received signal of the communication channel. The physical payload comprises normally another frame of the next higher OSI model layer, the data link layer, often referred as the MAC frame. The MAC frame comprises a MAC header MHR with communication management information about the sender, the receiver RX, the network connection, etc. The MAC payload comprises the data which should be transmitted. Even if this is a preferred organisation of the transmitted frame, other organizations are possible.

The message and/or frame is physically transmitted over a communication channel (short channel), in the aspects of this disclosure via a radio communication channel. The radio communication channel comprises a radio signal transmitting the message. The radio communication channel or the radio signal has a bandwidth. The bandwidth in the aspects of this disclosure can be either an ultra-wideband (UWB) or a narrowband (NB). The UWB has preferably a bandwidth of 50 MHz and more, even more preferably a bandwidth of 100 MHz and more, even more preferably a bandwidth of 200 MHz or more, even more preferably a bandwidth of 300 MHz or more, even more preferably a bandwidth of 400 MHz or more, most preferably a bandwidth of 500 MHz or more. The NB has a bandwidth that does not significantly exceed the channel's coherence bandwidth, i.e. is less than the coherence bandwidth of the channel. The NB has preferably a bandwidth smaller than 50 MHz, preferably smaller than 20 MHz, preferably smaller than 10 MHz, preferably smaller than 5 MHz, preferably smaller than 1 MHz, preferably smaller than 500 Hz. The bandwidth of the NB as defined here refers to the bandwidth used in one single NB communication channel. The data or bits of the message frame are transmitted by symbols. One symbol transports normally one or more bits depending on the modulation scheme. It is also possible that a symbol comprising a plurality of pulses transmits one bit. While a NB symbol (symbol of a NB channel) can be transferred over an unlimited time, but preferably long enough for high symbol energy, a UWB symbol is transferred in a short time period with a high instantaneous power. The UWB symbol can be for example some hundreds of ns long or even some microseconds, but each of the at least one UWB pulse that forms the UWB symbol is in the range of a nanosecond or less. The radio signal has a carrier frequency on which the message is transmitted. While traditionally, the NB carrier frequencies used for oob messages are in the ultra high frequency (UHF) band (below 3 GHZ) and the UWB carrier frequencies are in the super high frequency (SHF) band (above 3 GHZ). Preferably, in the aspects of this disclosure the carrier frequency of the NB channel, if used, is larger than 2.4 GHZ, preferably larger than 2.5 GHZ, preferably, larger than 3 GHz, preferably larger than 5 GHz. Preferably, the carrier frequency of the NB channel is chosen in vicinity of the carrier frequency of the UWB channel so that the same antenna and the same transceiver components can be used for the NB and UWB channel. Preferably, the carrier frequency of the NB channel is closer to carrier frequency of the UWB channel than 2 GHZ, preferably than 1 GHZ, preferably than 500 MHZ. Theoretically, also the same carrier frequency could be used for the NB and the UWB channel. However, for regulatory purposes and bandwidth sharing (e.g. multi-users), different carrier frequencies are preferred. The UWB channel can comprise different UWB sub-channels.

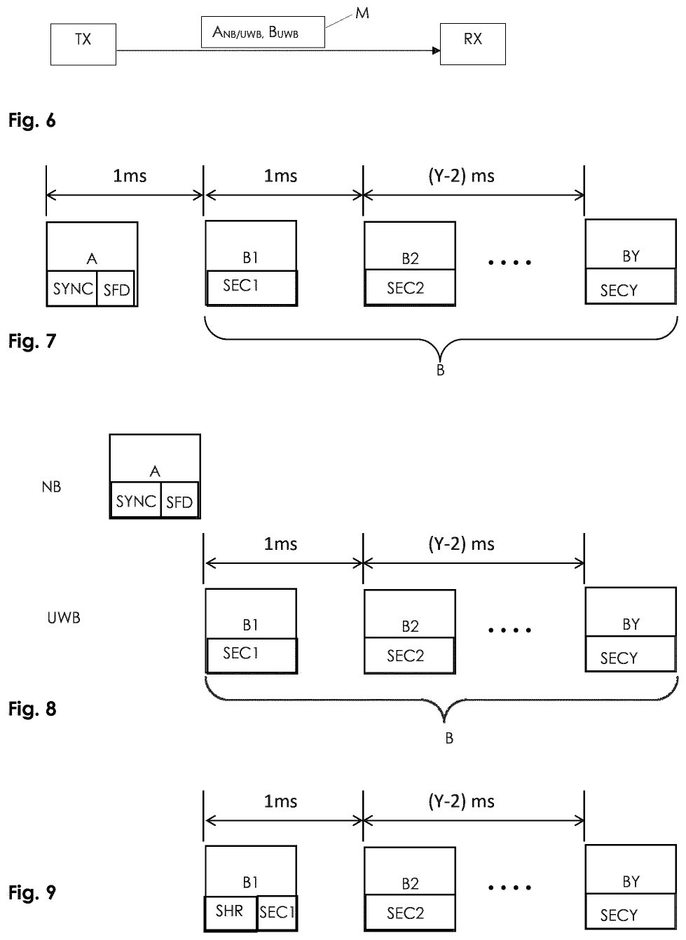

A message M is transmitted from a transmitting device TX to a receiving device RX as shown in FIG. 6. The transmitting device is shortly also called transmitter TX and/or the receiving device is also called shortly receiver RX. The transmitter TX is described as a device having all the functions necessary to transmit the message M, while the receiver RX is described as a device having all the functions necessary to receive the message M. However, in a preferred aspect, the transmitting device TX can act as receiver RX and transmitter TX, i.e. as transceiver. In a preferred aspect, the receiving device RX can act as receiver RX and transmitter TX, i.e. as transceiver. In such a case the transceiver has the functions of the transmitting device and the receiving device.

A distance pulse sequence is a sequence of UWB pulses used at the receiver RX to measure a time of arrival of a received message M. The time of arrival of the received message M can be used to calculate a time of flight, e.g. a time between sending of a previous message M and the time of arrival measured (e.g. a verifier time difference) or a time between the time or arrival measured and a time a subsequent message is sent out (e.g. a prover time difference). The distance pulse sequence according to the aspects of this disclosure is always transmitted in the UWB channel. This time of arrival measurement is sometimes also called timestamping of the received message M. So, other UWB pulses or NB symbols transmitted before or after the distance pulse sequence not directly used to measure the time of arrival are not considered as distance pulse sequence. The distance pulse sequence corresponds to a distance bit sequence. Thus, the distance bit sequence refers to the bit sequence behind the transmitted distance pulse sequence. The number of pulses of the distance pulse sequence is normally equal to the number of bits of the distance bit sequence but can be also higher or lower than the number of bits of the distance bit sequence. In some aspects, one bit of the distance bit sequence corresponds to one UWB pulse of the distance pulse sequence leading to the same number of bits of the distance bit sequence than the number of pulses in the distance pulse sequence. An UWB symbol has normally one or more UWB pulses. It is also possible that a plurality of bits corresponds to a certain UWB symbol. It is further possible that one bit of the distance bit sequence corresponds to a UWB symbol with a plurality of UWB pulses like when using spreading codes. Also, the order of the bits or spreading codes corresponds normally to the order of pulses of the distance pulse sequence. However, it is also possible to rearrange the order of the bits (or of the chips of the spreading code) in the distance pulse sequence like for example in WO2017/121452. Thus, the term distance pulse sequence refers to the full sequence of UWB pulses used for the time of arrival measurement, i.e. preferably for the cross-correlation between the expected distance pulse sequence and the UWB signal transmitting the distance pulse sequence. The distance pulse sequence is the translation of the distance bit sequence in the physical layer of the OSI model, i.e. what is sent out from the device. The term distance bit sequence refers rather to the data behind the distance pulse sequence. These data or distance bit sequence can be already transmitted before the actual distance pulse sequence (but in encrypted form to keep the distance bit sequence secret). The distance bit sequence refers to the data carry by the distance pulse sequence above the physical layer of the OSI model. The abbreviation distance pulse/bit sequence shall mean the distance pulse sequence and/or the distance bit sequence.

In the state of the art the used distance pulse/bit sequence is well known for third parties, often a periodic bit sequence to facilitate the time of arrival detection, normally the preamble or SYNC pattern of the UWB message. In the aspects of this disclosure, the distance bit/pulse sequence is secret and/or changes from message to message. Thus, secret distance bit/pulse sequence shall mean that third party devices cannot know the used distance pulse sequence in advance to compromise the distance measurement, e.g. by anticipating the last part of the distance pulse sequence. The secret distance bit sequence is normally a cryptographically generated random number (nonce). It is also possible that only a portion of the distance bit/pulse sequence is secret. In this case, the secret distance bit/pulse sequence comprises at least one secret portion and at least one known portion. The secret distance bit/pulse could theoretically comprise one secret portion and one known portion following one after the other. In difference to the state of the art, the secret portion is also used for determining the time of arrival. However, it is preferred that the secret portion is interleaved with the known portion. Thus, the secret distance pulse sequence comprises known pulses and secret pulses and the secret pulses are distributed in between the known pulses. In one aspect, more than 20%, preferably more than 30%, preferably more than 50%, preferably more than 70%, preferably more than 80%, preferably more than 90%, preferably more than 95% of the pulses/bits of the distance pulse/bit sequence are secret, i.e. not known for an attacker. For example, the start of the distance pulse/bit sequence could be periodic, while the subsequent secret portion is for example random. But in such a case, both of the non-secret and secret portion of the distance pulse sequence are always used completely for time of arrival and completely for the verification step (see later). Most preferably the full distance bit/pulse sequence is secret. For the sake of brevity, the secret distance pulse/bit sequence is called distance pulse/bit sequence without the adjective secret but shall always intend (if not otherwise mentioned) to be a secret distance pulse/bit sequence.

The distance pulse sequence is in most cases transmitted by an equidistant sequence of pulses 41 which are transmitted equidistantly, i.e. with the same time difference between all pulses of the distance pulse sequence like shown in the example of FIG. 3. However, the distance pulse sequence can also be transmitted with another time order than in FIG. 3. An alternative is for example to transmit the pulses 41 of the distance pulse sequence in pulse groups 42 as shown in FIG. 4, i.e. as a group pulse sequence. The group 42 comprise at least two pulses 41. The group pulse sequence comprises a sequence of at least two groups (plurality of groups). The time difference between two subsequent pulses 41 of the same group 42 is smaller than the time difference TG between two subsequent groups 42. The pulses 41 of the same group 42 are normally sent shortly one after the other. Preferably, subsequent pulses 41 of the same group 42 have a time difference among them which is smaller than ten times the duration of the pulse 41, preferably than 8 time, preferably than 6 times preferably than 5 times, preferably than 4 times, preferably than 3 times the duration of the pulse 41. The time difference between two subsequent pulses 41 of the same group 42 is preferably smaller than or equal to ten times the pulse duration, preferably five times the pulse duration, preferably three times the pulse duration, preferably two times the pulse duration, preferably one time the pulse duration. The time difference among subsequent pulses shall be the time difference between the same characteristic point of the respective pulses 41, e.g. the peak of the pulses 41. The pulse duration is for example 2 ns and the pulses in the group 42 of pulses 41 is sent every 4 ns or 2 ns. Often the group 42 of pulses 41 is a symbol for a bit, also called a burst or a spread code. The pulses 41 of this symbol or group 42 are often also called chips. Such a spread code or burst 42 facilitates the reception of the transmitted bit sequence as the transmission energy for each bit is increased by a factor of the number of chips per symbol. However, the longer the symbol length becomes, the higher is the risk for a manipulation of the time of arrival by a malicious third party. Therefore, the pulses 41 are preferably sent as close together as possible to make a manipulation of the time of arrival as hard as possible. The group pulse sequence has the further advantage that the grouping of the pulses 41 leads to larger time differences between the groups 42 which avoids in environments with long channel impulse responses that the previous group 42 creates noise for the subsequent group. This facilitates the reception of the signal a lot and avoids complex and power consuming post processing of the received signal to filter out the channel impulse response.

The term distance bit information shall indicate any information allowing to determine the (secret) distance bit sequence from the distance bit information. The distance bit information can be the distance bit sequence itself. In other aspects, the distance bit information can be shorter than the distance bit sequence. For example the distance bit information can be a seed information which allows to determine by a (cryptographic) function to determine the distance bit information. The latter aspect allows, when the distance bit information must be (secretly) exchanged between the transmitting device and the receiving device to reduce data amount to be exchanged.

The previous explanation of the message M shall apply equally for the secure distance message M according to the disclosure.

FIG. 5A shows a first example of the message frame of the secure distance message M according to the disclosure. The secure distance message M is a standard UWB message including the synchronization header SHR and optionally the MAC header PHR. The (MAC) payload of the message M contains the secure distance bit sequence transmitted with a secure distance pulse sequence. The complete message M is transmitted in the UWB channel and in the same UWB time slot and in the same UWB sub-channel.

FIG. 5B shows a preferred aspect of the message frame or protocol of the secure distance message M. The message M contains in a common message frame a first information portion A and a second information portion B. The second information portion is always transmitted in the UWB channel.

The first information portion is in one aspect transmitted in the same UWB channel as the second information portion, but preferably in a distinct UWB frequency-time portion than the second information portion. One UWB frequency-time portion is defined as a portion of the UWB frequency-time domain limited by the TX budget LB. Two different UWB frequency-time portions have thus each an independent TX budget LB so that the two different UWB frequency-time portions allow to send together the energy of two times the TX budget LB in the UWB spectrum. Two different UWB frequency-time portions can be two different UWB sub-channels or two different TX budget (time) slots. Two different UWB sub-channels means that the first information portion A and the second information portion B are sent in different UWB sub-channels of the UWB channel, i.e. at different carrier frequencies. Two different TX budget (time) slots mean that the first information portion A and the second information portion B are sent in different UWB TX budget (time) slots, i.e. normally Ims after the start of the first information portion A, such that the second information portion B has again the TX budget available. Such an aspect is shown in FIG. 7. In this aspect, the first information portion A is intended as the complete information of the message M transferred in a first UWB frequency-time portion (before the second information portion B) and the second information portion B is intended the complete information of the message M transferred in at least one second UWB frequency-time portion (being different from the first frequency-time portion).

In another aspect, the first information portion is transmitted in the NB channel as shown in FIG. 8. In this aspect, the first information portion A is intended as the complete information of the message M transferred in the NB channel (before the second information portion) and the second information portion B is intended the complete information of the message M transferred in the UWB channel. In a preferred aspect, the message M does not comprise other portions than the first information portion A and the second information portion B so that the message consists of the first information portion A and of the second information portion B. However, it is also possible in another aspect that a third information portion is transmitted after the second information portion in the NB channel. Preferably, the first information portion A and the second information portion is sent using the same oscillator/clock in the transmitter and is received using the same oscillator/clock in the receiver RX. This allows to determine the clock-offset in the UWB channel by the clock-offset recovered in the NB channel.

The first information portion A is transmitted (in the NB or UWB channel) before the second information portion B. Preferably, the second information portion B is transmitted after the first information portion A has been fully transmitted, i.e. the second information portion B is transmitted only after the end of the first information portion A has been transmitted. Preferably, the second information portion B has a well-defined time relationship with respect to the first information portion A. The well-defined time relationship allows a receiver RX receiving the message M with the common frame to know based on the time of arrival of the first information portion and based on the well-defined time relationship to know/calculate the expected arrival of the second information portion B. Where the first information portion A is transmitted in the UWB channel, the second information portion B can be sent at least one TX budget time period after the start of the first information portion A so that the second information portion B has again the full TX budget available. The TX budget time period is the regulatory time defined in the UWB radio standard after which the UWB channel provides again the full TX budget. Currently the TX budget time period is 1 ms. Where the first information portion A is transmitted in the NB channel, the well-defined time relationship can for example be a fixed time period between the end of the first information portion A and the beginning of the second information portion B. In one aspect, the symbol length of the NB channel of the first information portion A and the symbol length of the second information portion B can be equal, so that the UWB symbols of the second information portion can be arranged in multiples of the symbol length after the NB symbols of the first information portion A. However, many other well-defined time relationships can be realized.

The first information portion A comprises preferably a synchronization information, preferably a synchronization header SHR as in classical frames as shown in FIG. 2. The synchronization header or the synchronization information comprises preferably the preamble SYNC and the SFD. As explained above, the SHR or the preamble SYNC can used at the receiver RX to detect the message M in the radio channel and to determine the clock-offset. The receiver RX can for example detect a message M in a radio channel by correlating the received signal of the radio channel with a reference signal which corresponds to a radio signal containing the synchronization information, the SHR and/or the preamble SYNC. When the correlation gets high, the receiver RX knows that a message M is received. Due to the longer symbols in the time domain and the sharper frequency shape of the symbols and due to a higher transmission amplitude (no energy limitation per ms as in UWB), it is much easier, less power consuming and less error-prone to detect the message M in in the NB channel than the detection of a message or SHR in the UWB channel.

A transmitter TX, receiver RX or transceiver has normally one oscillator defining the clock of the transmitter TX, receiver RX or transceiver. This clock or oscillator is used to create the carrier frequency and to decide the time of transmission or reception of a bit, pulse or symbol of the signal. The receiver RX determines a clock offset based on the first information portion A. Contrary to the time of arrival of a NB message, the clock-offset between the receiver RX and the transmitter TX can be determined even more precisely than from an UWB portion of the message M. The receiver RX preferably determines from the synchronization information, the SHR and/or the preamble the clock offset. The clock offset defines the offset of the system clock of the receiver RX from the system clock of the transmitter TX. When the transmitter TX has a different system clock (than the receiver RX), the symbol can differ in length (time drift) and carrier phase (phase rotation) between the transmitter TX and the receiver RX, thus reducing the TX budget and the maximum range of the communication. Thus, if the clock offset is not considered at the receiver RX, this leads to a different length and/or different carrier phase of a symbol of the message M transmitted at the transmitter TX and expected at the receiver RX. Therefore, it is important for the receiver RX to know the clock offset so that his time reference when a symbol is expected to be received at the receiver RX based on the synchronization above does not drift due to the different system clocks. It also important for the receiver RX to synchronize on the phase of the transmitter TX such that demodulation performance is not degraded in a coherent signalling scheme. Therefore, the receiver RX detects the second information portion B of the message M using the system clock of the receiver RX and the clock-offset determined based on the first information portion A. Either the receiver RX adapts based on the clock offset the system clock of the receiver RX and detects the second information portion B based on the adapted system clock. Or the receiver RX post-processes the UWB signal with the second information portion B based on the determined clock-offset.

The receiver RX can also determine the frequency offset for the frequency of the carrier signal. The frequency offset can be determined from the determined clock-offset or vice versa. The receiver RX can then adapt the frequency of its oscillator for generating the carrier signal by the determined frequency offset.

The first information portion A comprises preferably further a PHR. The PHR comprises preferably the information about the length of the message M so that the receiver RX will know, when the last symbol of the message M and/or of the first information portion A has been received. In one aspect, the PHR could comprise just the length of the full message M or any other information allowing the determination of the full length of the message M. In a preferred aspect, the PHR could comprise the information of the length of the first information portion A (or any other information allowing to determine the length of the first information portion A) and the length of the second information portion B (or the length of its sub-portions). Thus, the physical layer in the receiver RX could already determine from the PHR when the first information portion A ends, thus when the second information portion B starts and thus, when the receiving mode of the UWB receiver RX must be switched on. However, it is also possible to include the information about the length of the first information portion A in the remaining first information portion A, e.g. in the physical or MAC payload P.

The rest of the message M contains the physical payload P. The physical payload is divided in the first information portion physical payload P1 defining the remaining data of the first information portion A and in the second information portion B. In another aspect, the first information portion physical payload P1 can also be omitted and the full physical payload P is transmitted in the second information portion or the UWB channel.

The first information portion A (physical payload P1) comprises preferably (at least a part of) a Media Access Control (MAC) frame. The MAC frame comprises normally a MAC header (MHR) at the beginning of the MAC frame, the MAC payload and a MAC footer at the end of the MAC frame. The MHR is preferably the first information transmitted in the first information portion physical payload. The MHR contains normally communication management information like for example frame control counter, sequence number, source address, destination address and/or other communication management information. The MAC footer can be transmitted as last information of the first information portion A or as last information of the second information portion B. This depends, how the frame of the message M is defined, if the MAC frame extends over both of the first and second information portion or only over the first information portion A.

The first information portion A (physical payload P1), preferably the MAC payload comprises the information which shall be exchanged with the message M, preferably further non time relevant distance measurement information like one or more of a SSID, a distance bit information and the prover time difference. The distance bit information is preferably transmitted in encrypted form or such that a third party cannot retrieve the secret distance bit sequence from the distance bit information. However, the information is optional and can also be transmitted in an out-of-bound message.

The second information portion B comprises the distance pulse sequence SEC as shown in FIG. 5B. Since the same secret distance pulse sequence SEC is used for distance measurement and for authenticating the transmitter, the full available UWB TX budget of the second information portion B can be used for the distance measurement and at the same time for the security. In a preferred aspect, the second information portion B does not comprise a separate/full UWB message header with one or more of a preamble (equivalent to SYNC), SFD, PHR, MHR and SSID. This is possible, when the header information is transmitted in the first information portion A. This allows to increase the TX budget of the distance pulse sequence SEC of the message M or of the second information portion B which allows more robust/secure distance measurement. The TX budget of the distance pulse sequence SEC could be increased by dedicating the full TX budget for that sequence, i.e. using a distance pulse sequence with a higher number of pulses and/or by using a higher power/amplitude for sending the pulses of the distance pulse sequence. In one aspect, the second information portion B comprises only the distance pulse sequence SEC which allows for example to use the full available TX budget for the distance pulse sequence. In another aspect, other information can be transmitted in the second information portion B than the pure distance pulse sequence. For example, a reduced UWB message header can be sent within the second information portion B as well. This reduced UWB message header could comprise just the SYNC pattern or even a reduced SYNC pattern. In one aspect, the second information portion B is transmitted in the UWB channel without a message portion comprising a preamble, a start of frame delimiter SFD and packet header PHR. This message portion including the preamble, SFD and PHR which according to the standard is placed at the beginning of each UWB message is missing in the second information portion B as it has already been sent in the first information portion A. This aspect without this message portion shall not exclude a second information portion B comprising a reduced UWB message header not containing at least one of the preamble, SFD and PHR. For example, the second information portion could have just the preamble. In another aspect, second information portion B does not include at least one of the preamble, SFD and PHR, preferably does not include at least two of the preamble, SFD and PHR, preferably does not include all three of the preamble, SFD and PHR.

The use of a distinct first information portion A has the advantage that the header information including the SYNC pattern can be transferred outside the TX budget of the second information portion B. This increases the TX budget available for the secret distance pulse sequence SEC and allows pulse sequences with higher energy. This reduces the problem of the fake paths. This realisation is particularly advantageous as the SYNC pattern of the header information is not any more used for distance measurement according to the aspects of the disclosure and can thus be moved out of the TX budget of the second information portion B without having to repeat such a SYNC pattern for distance measurement in the second information portion B. Even if it is preferred that the secure distance message M comprises a first information portion A (transmitted in the NB channel or transmitted in a separate UWB frequency-time portion) and that the second information portion B can have a removed or reduced header information of the message M, it is also possible to send the message M without such a first information portion A so that the necessary header information is sent in the second information portion B in the same UWB frequency-time portion as the SEC as shown in FIG. 5A. This however reduces the available length/power/TX budget of the distance pulse sequence SEC. The aspect in which the first information portion A is transmitted in the NB has the further advantage that the clock-offset between transmitter TX and receiver RX can be determined with a higher precision in the NB than in the UWB so that the estimated time of arrival of the second information (sub-) portion(s) B and/or the time instants of the pulses of the expected distance pulse sequence SEC in the UWB signal can be determined in this aspect with a higher precision.

FIGS. 7, 8 and 9 show a preferred aspect of the disclosure, in which the second information portion B comprises a plurality of second information sub-portions B1, B2, . . . , BY. Each second information sub-portion B1, . . . , BY corresponds to a different UWB frequency-time portion. The different UWB frequency-time portions can be Y different UWB frequency portions transmitted in Y different sub-channels, can be Y different UWB time portions corresponding each to Y different UWB TX budget (time) slots or a combination of the two with the second information sub-portions B1, . . . , BY transmitted in different UWB frequency portions and in different UWB time portions. In the latter case, e.g. each UWB TX budget slot could comprise two or more different UWB frequency portions transmitted each in a different UWB sub-channel. In a preferred aspect, each second information sub-portion B1, . . . , BY corresponds to a different different TX budget (time) slot. That is the Y second information sub-portions B1, . . . , BY are transmitted in Y different UWB TX budget time slots. The number Y is the number of sub-portions Bi with i=1, . . . , Y. The distance pulse sequence SEC comprises in this aspect a plurality of Y distance pulse sub-sequences SEC1, . . . , SECY. Each of the different distance pulse sub-sequences SECi is transmitted in a different second information sub-portion Bi, with i=1, . . . , Y. In other words, the first distance pulse sub-sequence SEC1 is transmitted in the first second information sub-portion B1 and the second distance pulse sub-sequence SEC2 is transmitted in the second second information sub-portion B2, . . . , and the Y-th distance pulse sub-sequence SECY is transmitted in the Y-th second information sub-portion BY. The different distance pulse sub-sequences SEC1, . . . , SECY are preferably distinct from each other so that it is more difficult for a malicious third party to compromise the message M. However, it could also be possible that the different distance pulse sub-sequences SEC1, . . . , SECY are the same. Y is preferably two, four, six or eight. Obviously, other numbers Y are possible. In case, Y is chosen 1, only one second information (sub-)portion B(1) is sent as described in the aspect above.

The aspects of the disclosure are particularly advantageous for very secure and robust UWB distance measurements which would normally require 2X second information sub-portions Bi, with i=1, . . . , 2X, with X second information sub-portions transmitting the periodic distance pulse sequence N of the state of the art and the other X second information sub-portions transmitting the security distance information SEC1, . . . , SECX (not used for the distance measurement). Thus, for the same robustness and security, two times the number of second information sub-portions Bi are required in the state of the art. However, if the number 2X of second information sub-portions Bi becomes too high, e.g. sixteen, the drift in the clock-offset could lead to severe problems for the last second information sub-portions Bi. Since the aspects of the disclosure reduce at the same security and robustness level the number of necessary second information sub-portions Bi by two, the disclosure is particularly interesting for disclosures with a plurality of second information sub-portions Bi. In addition, the use of the first information portion A the use of multiple second information sub-portions B1, . . . , BY allow to use longer secret distance pulse sequences SEC as the TX budget of the secure distance message M is increased. This reduces the size of the fake peaks.

FIG. 9 shows an aspect, in which there is no first information portion A, but the message header information and a first secret distance pulse sub-sequence SEC1 is transmitted in the first second information portion B1, while the remaining second information sub-portions B2, . . . , BY transmit the remaining secret distance pulse sub-sequences SEC1, . . . , SECY. As in the previous aspect, the multiple UWB frequency-time portions allow to increase the available TX budget above the regulatory limit to transfer even longer secret distance pulse sequences which further reduces the fake peaks in the cross-correlation.

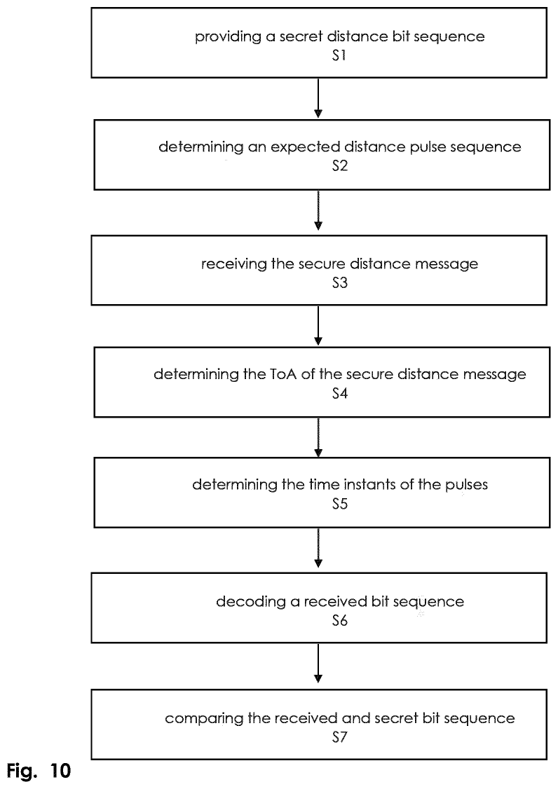

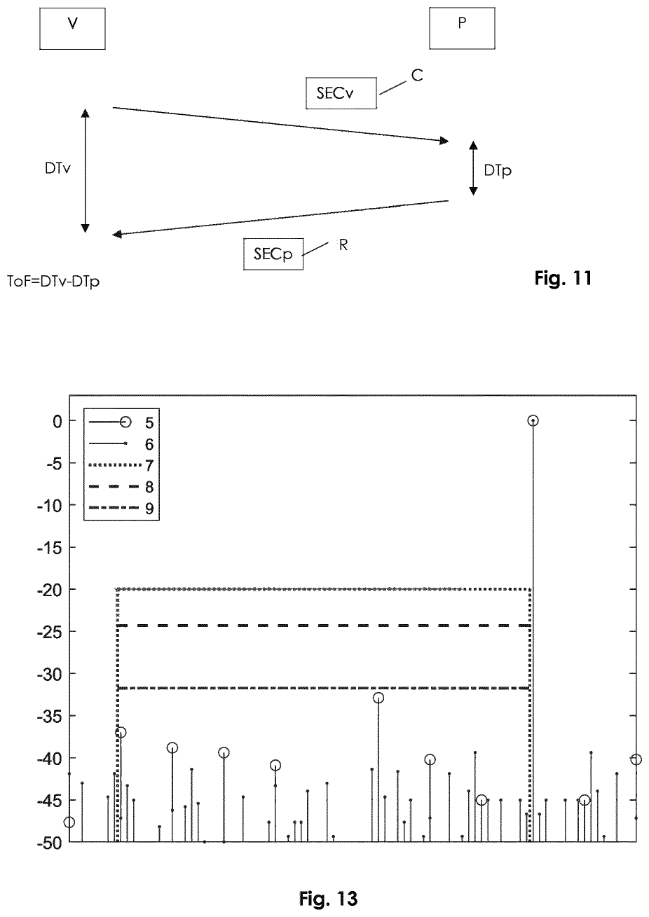

FIG. 10 shows the method according to the aspects of the disclosure for measuring the time of arrival of a secure distance message M. A transmitter TX transmits a secure distance message M including the distance pulse sequence SEC. The distance pulse sequence corresponds to the secret distance bit sequence. As explained before, at least the distance pulse sequence SEC is transmitted in the UWB channel. The following steps correspond to an aspect of the method to determine the time of arrival of the secure distance message M at the receiver.

In step S1, a secret distance bit sequence is provided at the receiver RX. The secret distance bit sequence can be determined from a secret distance bit information. The secret distance bit information can be received from the transmitter TX. The secret distance bit information is preferably transmitted in a way that a third party cannot determine the secret distance bit sequence based on the transmitted form of the distance bit information. The distance bit information can for example be encrypted (by a shared key of the transmitter TX and receiver RX or by a public key of the receiver RX). The transmitter TX can transmit the secret distance bit information for example in the secure distance message M itself, e.g. in the first information portion A, preferably the first information portion payload P1. The transmitter TX can however also transmit the distance bit information in another message, e.g. in an out-of-band channel/message before or after sending the secure distance message M. The distance bit information can also be received by another party than the transmitter TX, e.g. a device which sends the distance bit information (secretly) to the transmitter TX and the receiver RX.

In step S2, the receiver RX determines an expected distance pulse sequence corresponding to the secret distance bit sequence provided in S1. The expected distance pulse sequence corresponds to the UWB radio signal as expected to be received in the UWB channel, when the secure distance message M is received. The expected distance pulse sequence can be for example be determined based on the secret distance bit sequence provided in S1 and the message protocol of the physical layer, i.e. the expected distance pulse sequence would correspond to the UWB signal of the secret distance pulse sequence as transmitted from the transmitter TX. In a more complex solution, the expected distance pulse sequence can be for example be determined based on the secret distance bit sequence provided in S1 and the message protocol of the physical layer and the channel impulse response (CIR) of the used UWB channel, i.e. the expected distance pulse sequence would include also include the multiple paths of the CIR. In this case, the CIR is obviously not determined from the distance pulse sequence. The CIR could be determined based on the first information portion A, preferably based on the synchronization information, preferably based on the SNYC pattern, if the first information portion A is transmitted in the UWB channel. When the first information portion A is transmitted in the NB channel, the CIR could be determined based on a known message portion/pattern which is transmitted in the UWB channel used to transmit the second information portion B. For example, the second information portion B could contain in this case a small SYNC pattern just to determine the CIR for the UWB channel. Or the CIR could be retrieved from a separate UWB message. In a simple aspect, each bit of the secret distance bit sequence corresponds to a pulse of the secret distance pulse sequence with a pulse value corresponding to the bit value. However, it is also possible that a first number of bits of the secret distance bit sequence corresponds to a second number (different to the first number) of pulses of the secret distance pulse sequence. In the case of a secret distance pulse sequence transmitted via time hopping (see aspect described in more detail below), the position of the pulses of the of the secret distance pulse sequence must be arranged as transmitted from the transmitter TX.

In step S3, the secure distance message M is received at the receiver RX from the transmitter TX.

If the secure distance message M has a first information portion A, the receiver RX receives the first information portion A in the NB or UWB channel. The receiver RX determines preferably the (rough) time of arrival of the first information portion A and/or the clock-offset between receiver RX and transmitter TX. Based on the determined time of arrival and/or clock-offset, the receiver RX determines the rough time of arrival of the second information portion B, in case of Y>1, the time of arrival of all Y second information sub-portions B1, . . . , BY. This allows for example to receive the UWB signal in the UWB channel just for the estimated time window in which the second information (sub-)portion(s) B is/are expected. Since the UWB receiver is quite energy hungry, this would save already some energy of the receiver RX. Since the receiver RX works much more power-efficient in the NB channel, the aspect with the first information portion A sent in the NB reduces the power consumption of the receiver RX quite a lot as the receiver RX is not forced to be switched on for a long time before finally receiving the secure distance message M. The UWB signal of the second information (sub-)portion(s) is preferably digitalized by an analogue-digital-converter and processed subsequently digitally. However, it is also possible to perform the subsequent processing steps analogue processing. In the case of multiple second information sub-portions B1, . . . , BY, the UWB signal containing the different distance pulse sub-sequences SEC1, . . . , SECY can be a signal with the signal “islands” Bi every ms. The signal “islands” corresponding to the UWB signal portions carrying the second information sub-portions B1, . . . , BY. However, it is also possible to reduce the time between the second information portions B1, . . . , BY by cutting out parts or all of these (non-information-containing) signal portions, if the same is done in the expected distance pulse sequence. It is preferred to send the secure distance message with a prior first information portion A to have the full or at least an increased TX budget available for the distance pulse sequence SEC, but it is also possible to send the secure distance message M without such a first information portion A. The first information portion A is particularly advantageous as the preamble of the second information (sub-)portion(s) in the UWB channel is not needed any more for the time of arrival measurement and can thus be transmitted in the first information portion A (in the NB or UWB channel). The TX budget of the second information (sub-)portion(s) can thus be maximized for the secret distance pulse sequence SEC.

In step S4, the time of arrival of the secure distance message M at the receiver RX is determined based on the expected distance pulse sequence and the UWB signal of the secure distance message M containing the distance pulse sequence SEC. Preferably, the time of arrival of the secure distance message M is determined at the receiver RX based on a cross-correlation between the expected distance pulse sequence and the received UWB signal. The cross-correlation moves the expected distance pulse sequence over the UWB signal corresponding to the secure distance message M, more precisely of the second information (sub-)portion(s) B. When the expected distance pulse sequence corresponds to the UWB signal, the cross-correlation will show a peak. Due to the noise, second best matches and different paths of the secure distance message M, the cross-correlation will show several peaks. The time of arrival of the shortest or earliest path might not necessarily correspond to the highest peak. Some smaller earlier peaks might correspond to a weaker earlier path which would be the true time of arrival of the shortest path of the secure distance message M. Therefore, the estimation of the time of arrival might comprise the step of detecting a weaker earlier path before the largest peak of the cross-correlation. Preferably, an early path time window 7 is defined before the time of arrival of the largest peak of the cross-correlation (strongest path). The end of the early path detection window is preferably the time of largest path and the start might be defined by a certain time before the time of the largest path. Such an early path time window 7 is exemplary shown in FIG. 13. However, some smaller (fake) peaks might be due to a second-best match of the expected distance pulse sequence on the UWB signal with an off-set of one or multiple pulses as explained before and afterward or simply due to the noise level. Therefore, often the time of arrival of the earliest peak which is larger than a certain threshold is considered as the time of arrival of the secure distance message M. If such an weaker early path is detected in the early path time window 7, the time of the early path is defined as the time of arrival of the secure distance message M. If the distance pulse sequence comprises a plurality of Y distance pulse sub-sequences, the cross-correlation is based on a signal comprising all distance pulse sub-sequences one after the other. This can be done with the full real time signal break in between the second information portions B1, . . . , BY, with a reduced signal break in between them or by concatenating the Y distance pulse sub-sequences SEC1, . . . . SECY one after the other without any signal break.

In step S5, the time instants of the pulses of the expected distance pulse sequence SEC are determined in the UWB signal based on the determined time of arrival of the UWB secure distance message M. In other words, the time instants determined in this step correspond to the time of arrival of the pulses of the secret distance pulse sequence of the message path related to the determined time of arrival. Since the message protocol/frame of the secure distance message M is known, the time instants of each pulse of the distance pulse sequence are known within the secure distance message M. Once the time of arrival of the secure distance message M is determined, the time instants of the respective pulses can be computed. Preferably, the time instants of each pulse are determined based on the time of arrival of the secure distance message M and based on the clock-offset. This includes also the case, where the time instants are calculated only with the clock of the receiver RX, but the receiver clock has been adapted before by the clock-offset. In the aspect described below using time hopping, the time position of each pulse of the secret distance pulse sequence must be considered to determine the time instants of pulses of the secret distance pulse sequence. If the secret distance pulse sequence has a known portion and a secret portion, it would be sufficient to determine the time instants of the secret pulses.

In step S6, a received bit sequence is decoded from the UWB signal at the determined time instants. The modulation parameter of the UWB signal at each time instant is determined to determine the corresponding bit value of the respective pulse (or pulses if several pulses correspond to one bit). Based on the modulation parameter of the UWB signal at the respective time instant, a bit value of the pulse at this time instant is determined. For example, for a binary amplitude modulation, a positive amplitude could mean a first bit value (e.g. 1) and a negative or zero amplitude could mean a second bit value (e.g. 0). For example, for a binary phase shift keying, a first phase could mean a first bit value (e.g. 1) and a second phase could mean a second bit value (e.g. 0). For example, for a binary frequency shift keying, a first frequency could mean a first bit value (e.g. 1) and a second frequency could mean a second bit value (e.g. 0). Preferably, (only) a small time window around each time instant is used to decode the transmitted bit of the respective pulse received at this time instant. In other words, only the pulses of the path related to the determined time of arrival is used to decode the secret distance bit sequence behind the secret distance pulse sequence, not the other or strongest path(s) or the full CIR of the pulse is used as is the case in normal UWB data decoding. The decoding time window around each time instant used for detecting the bit value of the pulse is preferably smaller than 20 nanoseconds (ns), preferably than 17 ns, preferably than 9 ns, preferably than 5 ns, preferably than 3 ns. The decoding time window can depend also on the security level, e.g. a time window of 2 ns for a very secure application and a time window of 16 ns for a less secure application. A time window of 16 ns might lead to a potential distance fraud of 3-5 metres. A further difference to the state of the art of distance measurement is that the security fragment, here the secret distance pulse sequence, is decoded bit by bit and not checked by some statistical methods allowing a large number of attacks. In the state of the art, this is normally done by a cross-correlation of the received UWB signal with the expected security fragment which is not done here for verifying the authenticity of the transmitter. If the secret distance pulse sequence has a known portion and a secret portion, it would be sufficient to decode the bit sequence only from the secret pulses. But it would also be possible to use the full sequence with known and secret pulses for the verification.

It is important for the disclosure that the same secret distance pulse sequence SEC is used for decoding the bit sequence received (S6) and for determining the time of arrival (step S4). Preferably, using the same secret distance pulse sequence SEC means that each pulse of the secret distance pulse sequence SEC is used once for the time of arrival measurement (S4) and once for the bit decoding (S6). However, in a less preferred aspect, it could also mean that the majority (more than 50%), preferably more than 70%, preferably more than 80%, preferably more than 90%, preferably more than 95% of the pulses of the secret distance pulse sequence SEC are used for the time of arrival measurement (S4) and for the bit decoding (S6).

By actually decoding the bit sequence transmitted by the path related to the determined time of arrival, the time of arrival measurement cannot be corrupted by third parties as in the state of the art. Since each bit is counted only once and independently of the energy of the pulse, attacks as described at the beginning of the patent cannot be used to guess the secret distance pulse sequence. Since the same sequence is used for time of arrival measurement and for the bit decoding, a potential drift between the distance pulse sequence and a security pulse sequence is avoided and the full TX budget of the UWB message can be used for the secret distance pulse sequence.

In step S7, the received bit sequence decoded from the UWB signal is compared with the secret distance bit sequence. The comparison result is used to verify the authenticity of the transmitter TX. In a first aspect, the transmitter TX is verified/authenticated by the reiver RX, if the received bit sequence is completely equal to the secret bit sequence. In a second preferred aspect, the transmitter TX is verified/authenticated by the reiver RX, if the received bit sequence shows a number of errors lower than a threshold. The threshold depends on the number of bits of the secret distance bit sequence and the desired security level. The threshold or allowed error rate k can be calculated based on the following formula:

$$Security level ( L , k ) = - {log}_{2} ( \frac{{\sum }_{n = 0}^{k} ( \begin{matrix}L \\ n\end{matrix} )}{{2}^{L}} )$$

where L is the length the number of bits of the secret distance bit sequence and the Security level is the cryptographic security level (corresponding to the number of bits of the secret distance bit sequence with an error rate of zero). With L=4096 (bits) and k<1848 (errors), the Security level is better than 32 bits. This aspect with an allowed error rate has the advantage that the verification is secure and robust as some errors are allowed. This is particularly advantageous for the present aspect, where the bit decoding is limited to the transmitted energy of only the path related to the determined time of arrival. So, the reduced energy used might lead to a higher error rate which is however compensated by a longer secret distance pulse sequence SEC which is also reduces the fake lobes. Especially, this solution is highly secure (due to the decoding strictly related to the selected path) and robust (due to the long distance pulse sequences SEC allowing a certain error rate corresponding to the desired security level).

As explained before, the use of the secret distance pulse sequence at the same time for determining the time of arrival of the message and for verifying the authenticity of the transmitter TX allows to double the length/power/TX budget of the pulse sequence used for the time of arrival measurement and of the pulse sequence used for the verification compared to the state of the art where two distinct pulse sequences have been used. Especially, when using longer messages with multiple UWB frequency-time portions, this reduces the length of the message at the same security and robustness and avoids problems with drifts due to errors in the detection of the clock-offset. The aspect with the first information portion A transmitted in the NB is particularly advantageous for the aspects of the disclosure as it allows to determine the cock-offset with a higher precision and allows thus to determine the time instants used for decoding the received distance pulse sequence with a higher precision.

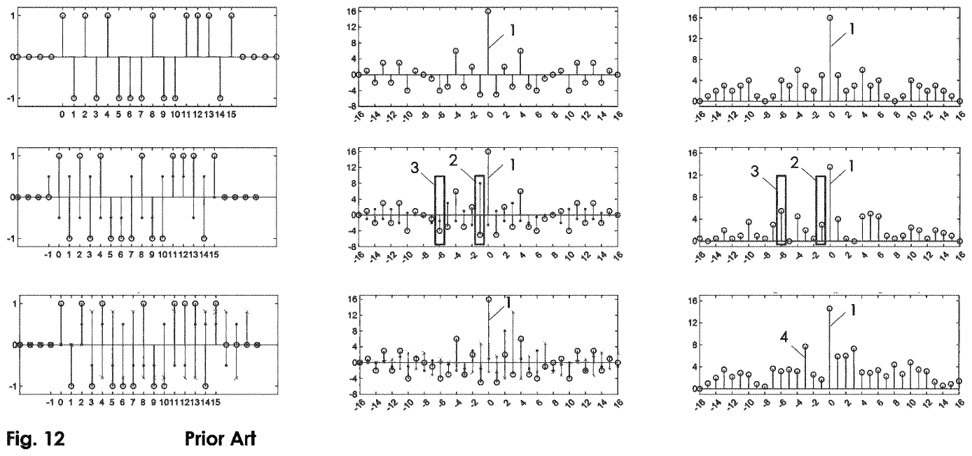

The use of the secret distance pulse sequence for time of arrival measurement brings the problem of fake peaks in the cross-correlation and could lead to fake early paths. This problem is already reduced due to the longer secret distance pulse sequence which can profit from the full TX budget available in the UWB message without reducing the TX budget with a separate specific distance pulse sequence. The problem of the fake paths can be further reduced by the following two improved aspects. Before describing the two improved aspects, the problem with the fake peaks is described better with a noise free simulation in FIG. 12 for a random distance pulse sequence.

The first row shows a situation with only one path (situation of free-space line of sight without reflections). The first column (of the first row) shows the received distance pulse sequence which in this case is equal to the transmitted pulse sequence. The second column of the first row shows the cross-correlation between the transmitted pulse sequence and the received pulse sequence, wherein the correlation value is shown positive or negative. The third column shows the absolute value of the cross-correlation function as received at the receiver. The correlations show at the delay zero (distance zero) the highest peak 1 which corresponds to the true peak of the only path.

The fake peaks would not be a problem in an environment, where the message is received only once with the shortest direct path. But in many situations, the message or the distance pulse sequence N is received at the receiver via multiple paths so that the cross-correlation shows multiple “true” peaks. The fake peaks can be confused with the weaker true paths or even worse reduce the power of the true peak. This can be a problem, when the shortest and earliest “true” path is not the strongest path, e.g. due to some shielding for example by a body (non line-of-sight, NLOS). The second and third row shall show phenomena in a simulation with the same random distance pulse sequence which is received via two or three paths, wherein the first column show the random pulse sequences of the multipaths, the second column the cross-correlation values of the individual paths and the third column the absolute accumulated cross-correlation value of all paths.

In the second row, the random distance pulse sequence is received via a weak early path (little dots) and a strong late path (big circles) which is received one inter-pulse distance later than the early path. The true late path 1 is clearly recognizable. However, the weak true early path 2 which is at position −1 is visible in the individual cross-correlation in the second column, but is weakened in this simulation by a negative fake path as seen in the third column. On the other side, two negative fake paths of the two paths at the position −6 cumulate to a strong fake path 3 in the third column. This shows that a fake path can obtain a stronger peak that the true early path. The third row shows a similar situation with a strong early path (large circle), a first late path (small dot) with a delay of two inter-pulse distances and a third late path (cross) with a delay of three inter-pulse distances with respect to the earliest path. As can be seen in the second and third column, the fake paths of the three paths of the delay position −3 create a strong fake peak 4 and may lead to a fake “early path” which in reality is not there. Thus, even the fake peaks of late paths can lead to the detection of fake early peaks.

In a first improved aspect, the fake peaks in the cross-correlation are reduced by applying a time-hopping on the transmitted pulses of the secret distance pulse sequence SEC. Instead of transmitting the pulses of the secret distance pulse sequence SEC at always the same inter-pulse sequence or at always the same two inter-pulse distances as shown in FIG. 3, a time-hopping is applied that there are more than two inter-pulse distances in the secret distance pulse sequence. Thus, the power of the cross-correlation of the fake peaks is divided on different time delays of the cross-correlation and the power of the fake peaks are in average reduced. The security pulse sequence of the state of the art was transferred using the STS scheme, i.e. the transmission of one pulse/bit every 8^{th} position of the normal UWB pulse. The position of each pulse could now be randomly changed around this 8^{th}-position, for example between the 7^{th} and the 10^{th} position (+/−2 positions) or between the 5^{th} and the 12^{th} position (+/−4 positions), the many different inter-pulse distances are created and the power of the fake peaks in the cross-correlation are divided on different fake peaks reducing their average energy/height. The periodicity of 8 positions around which the time hopping is applied is due to historical reasons and can be further increased so that the time hopping can be applied even over more positions. However, this is just one aspect. Also other realisations of the multiple different inter-pulse distances in the transmitted secret distance pulse sequence can be used. FIG. 13 shows the result of the cross-correlation 6 of a secret distance pulse sequence SEC transmitted with a time hopping (changing the position +/−4 positions) (illustrated with small dots) and of the cross-correlation 5 of a standard secret distance pulse sequence SEC with always the same inter-pulse distance (illustrated with large circles). The x-axis shows the time delay between the correlated functions and the y-axis shows the magnitude of the cross-correlation with respect to the maximum peak in decibel (dB). The result of the cross-correlation is shown mainly in the early path time window 7 which is used to determine potential weaker early paths. It can be clearly seen that the number of fake peaks 6 with time hopping increases, but their average peak value is reduced, while the fewer fake peaks 5 are higher in their value. This is also shown by the maximum value 8 of the fake peaks appearing in the simulation without time hopping which is 6 or 7 db higher than the maximum value 9 of the fake peaks appearing in the simulation with time hopping. The attenuation can be further increased by increasing the number of inter-pulse distances in the time hopping. This attenuation of 6-7 dB is quite important as it increases the ability to detect real paths above the floor of fake paths. Without the time hopping, there are several fake peaks above the noise level of −30 dB (also one in the early path time window) which could lead to wrong early path detections. The receiver RX must obviously know the used time hopping position for determining the correct expected secret distance pulse sequence in step S2 and/or for determining the time instants of the pulses in step S5. In a preferred aspect, the time hopping position of each pulse is chosen randomly, i.e. different in each secure distance message M. The used random position of the time hopping could be transferred from the transmitter TX to the receiver RX. Preferably, the used random position of the time hopping is determined based on the distance bit information. Thus, the receiver RX can use the distance bit information for determining the secret distance bit sequence (and the corresponding secret distance pulse sequence) and the position of each pulse of the secret distance pulse sequence. The distance bit information can be for example a seed information used to determine the secret distance bit sequence and a position bit sequence indicating the position of the pulses of the secret distance pulse sequence (corresponding to the secret distance bit sequence).

In a second improved aspect, after the detection of the strongest peak in the cross-correlation in step S4, a mismatched pulse sequence is generated which reduce the fake peaks in the early path time window. The mismatched pulse sequence corresponds to the secret distance pulse sequence with one or more pulses flipped to the opposite value. A plurality of mismatched pulses are tried and their cross-correlation with the received UWB signal or with the theoretically expected secret distance pulse sequence is calculated in the early path time window. One of the plurality of tried mismatched pulses is chosen which reduces the fake paths in the early path time window. A few flipped pulses can significantly change the fake paths, but would not have a big influence on a true early path. So, the selected mismatched pulse sequence is used to compute the cross-correlation of the UWB signal in the early path time window and the early path is detected in this newly calculated cross-correlation.

In a third improved aspect, the secret distance pulse sequence has a known portion and a secret portion, wherein the known portion has a special code which reduces or removes fake peaks, preferably an IPATOV code. The special code comprises preferably a sequence of code values which can be a first value, a second value and a third value. The first value corresponds to first bit value (e.g. 1) or a first pulse value and the second value to a second bit value (e.g. 0) or a second pulse value. When such a special code is sent out, the subsequent code values are transmitted at periodic times or positions, i.e. two subsequent code values are sent out with the same time distance among them. All positions of the special code with the third value mean that no pulse is sent out at this position. In a preferred aspect, the pulses of the secret portion are now sent at some or all positions of the special code corresponding to the third value. The (third value) positions of the special code where the secret pulses are transmitted can be fixed, but only their value change each time. In another aspect, the (third value) position chosen for sending the secret pulses could change from message to message. This aspect has the advantage that the fake peaks are reduced by the property of the special code with respect to a fully random sequence.

Any (sub-)combination of the first, second and third improved aspects is possible. For example, the time hopped secret pulse sequence can be mismatched to reduce the fake peaks. Also it is possible to apply a time hopping on the position of the secret pulses in the special code (without change the time position of the known pulses). This sums up the reduction effect on the fake paths of the different improved aspects.

FIG. 11 shows the use of the above-described secure distance message M for UWB distance measurement. It shows a system and method for secure distance measurement using the above-described method of secure time of arrival measurement.

The system and/or method comprises a verifier V and a prover P.

The verifier V sends a challenge message C with a challenge distance pulse sequence SECv to the prover P. The challenge message C is a secure distance message as described above. The challenge distance pulse sequence SECv is a distance pulse sequence as defined above. For the secure distance message C, the verifier V acts as transmitter TX and the Prover P acts as receiver RX. The prover P receives the challenge message C, determines the time of arrival of the challenge message C based on the challenge distance pulse sequence SECv and verifies the authenticity of the verifier V or of the challenge message C based on the same challenge distance pulse sequence SECv as described in more detail in the method above illustrated in FIG. 10. The challenge distance pulse sequence SECv is preferably transmitted in the second information (sub-)portion(s) B. The challenge distance bit information (corresponding to the challenge distance pulse sequence SECv) can be transmitted in the first information portion, preferably encrypted. The encryption is based on a common key known by both verifier V and prover P, preferably a symmetric key. However, it is also possible that the first distance bit information is transmitted in another message before or after the first message C. The first information portion A (payload P1) of the challenge message C comprises preferably an identifier (SSID) of the verifier V/Transmitter TX, an identifier (SSID) of the prover P/receiver RX, the SHR and/or the PHR.

The prover P determines the prover time difference DTp based on the time of arrival of the challenge message C and the time of transmitting a response message R back to the verifier V.

The prover P sends back a response message R to the verifier V. The prover P is thus now the transmitter TX, the response message R the secure distance message M and the verifier V the receiver RX. The verifier V receives the response message R, determines the time of arrival of the response message R based on the response distance pulse sequence SECp and verifies the authenticity of the prover P or of the response message V based on the same response distance pulse sequence SECp as described in more detail in the method above illustrated in FIG. 10. The response message R, preferably the second information (sub-)portion(s) B comprises the response pulse sequence SECp. The response pulse sequence SECp is a distance pulse sequence as defined above. The prover P transmits, preferably in the first information portion A of the response message R, the prover time difference DTp and/or the response distance bit information corresponding to the response distance pulse sequence SECp. The first information portion A (payload P1) of the response message R comprises preferably an identifier (SSID) of the verifier V/receiver RX, an identifier (SSID) of the prover P/transmitter TX, the SHR and/or the PHR.

The verifier V determines the verifier time difference DTv between sending out the challenge message C, in particular the challenge pulse sequence SECv and receiving the response message R, in particular the response pulse sequence SECp at the verifier V. The verifier V calculates then the time-of-flight ToF as the difference of the verifier time difference DTv and the prover time difference DTp. The prover time difference DTP is preferably received from the prover P. It is however also possible that the prover time difference is fixed to a certain time difference which the prover P waits each time before sending back the response message R.

If the time-of-flight ToF or the corresponding distance is smaller than a threshold and if the authenticity of the prover P and the verifier V was approved at the respective receiver RX, a certain request can be approved, e.g. opening the door of a car. If the prover P cannot verify the authenticity of the verifier V or the verifier V cannot verify the authenticity of the prover P, the process can be stopped or the certain request would be denied.

A wake up message could be sent from the verifier V to the prover P to switch on the receiver RX of the prover P, especially, when the first information portion A is sent in the UWB channel which is very power consuming.

It should be understood that the aspects of the disclosure are not limited to the described aspects and that variations can be applied without going outside of the scope of the claims.

1-15. (canceled)

16. A method for ultra-wideband (UWB) secure time-of-arrival measurement of a secure distance message transmitting in a UWB channel a distance pulse sequence corresponding to a secret distance bit sequence from a transmitting device to a receiving device, the method comprising:
providing the secret distance bit sequence at the receiving device;
determining at the receiving device an expected secret distance pulse sequence corresponding to the secret distance bit sequence as expected to be received in the UWB channel, when receiving the secure distance message;
receiving at the receiving device the secure distance message from the transmitting device, wherein the received secure distance message contains a UWB signal containing the secret distance pulse sequence corresponding to the secret distance bit sequence;
determining the time-of-arrival of a path of the secure distance message at the receiving device based on the expected secret distance pulse sequence and the UWB signal containing the secret distance pulse sequence of the received secure distance message;
determining time instants of the pulses of the expected secret distance pulse sequence of the path in the UWB signal based on the determined time-of-arrival of the path of the secure distance message;
decoding from the UWB signal at the determined time instants of the respective UWB pulse values their respective bit values to determine a bit sequence received by the path of the secure distance message; and
comparing the received bit sequence decoded from the UWB signal with the secret distance bit sequence provided to verify authenticity of the transmitting device and integrity of the time-of-arrival measurement.

17. The method according to claim 16, wherein the step of comparing the received bit sequence decoded from the UWB signal with the secret distance bit sequence provided comprises determining a number of errors of received bit sequence with respect to the secret distance bit sequence and considering a transmitter as verified, if the number of errors determined is below a threshold.

18. The method according to claim 16, wherein at each time instant of the UWB signal determined, the bit of this time instant is decoded from a time window of the UWB signal around the time instant, wherein the time window is smaller than or equal to sixteen nanoseconds.

19. The method according to claim 16, wherein the same pulses of the secret distance pulse sequence are used at the receiver once for detecting the time-of-arrival and once for decoding the bit values of the pulses.

20. The method according to claim 16, wherein the secret distance pulse sequence is transmitted in the UWB channel using a time hopping method with two or more different inter-pulse distances.

21. The method according to claim 16, wherein the time-of-arrival of the secure distance message at the receiving device is determined based on a cross-correlation between the expected secret distance pulse sequence and the received UWB signal.

22. The method according to claim 21, further comprising:
determining an early path time window before a maximum value of the cross-correlation, wherein a weaker early path is detected in the early path time window.

23. The method according to claim 22, further comprising:
computing a mismatched distance pulse sequence that varies some pulse values of the secret pulse sequence to minimize fake peaks in the cross-correlation in the early path time window, wherein the weak early path is determined based on the cross-correlation in the early path time window between the mismatched distance pulse sequence and the UWB signal received.

24. The method according to claim 16, further comprising:
providing each pulse of the secret distance pulse sequence with a first pulse value or a second pulse value, wherein the secret distance pulse sequence comprises known pulses and secret pulses,
wherein a known pulse is a pulse whose pulse value is known, wherein a secret pulse is a pulse whose pulse value is secret, wherein the known pulses follow a special code which reduces or removes fake peaks, and wherein the special code comprises a first code value corresponding to the first pulse value, a second code value corresponding to the second pulse value, and a third code value corresponding to not sending out a pulse; and
sensing the secret pulses at a position of at least some of the third code values in the special code.

25. The method according to claim 16,
wherein the secure distance message comprises a first information portion and a subsequent second information portion, and wherein the second information portion contains a secure distance bit sequence, and
wherein the method further comprises using the first information portion to detect the secure distance message in a received signal and/or to determine a clock offset between a system clock of the receiving device and a system clock of the transmitting device.

26. The method according to claim 25, wherein either
the secure distance message comprises a message frame in a physical layer with the first information portion transmitted in a narrowband channel and the second information portion transmitted after the second information portion in the UWB channel with a time relation between the first information portion and the second information portion defined by the message frame in the physical layer; or
the secure distance message comprises a message frame in the physical layer with the first information portion transmitted in a first UWB frequency-time portion and the second information portion transmitted in at least one second UWB frequency-time portion, wherein each UWB frequency-time portion is defined as a portion of an UWB frequency-time domain limited by a transmission budget of the UWB channel, wherein the first UWB frequency-time portion is different from the second UWB frequency-time portion.

27. The method according to claim 26, wherein the second information portion comprises a plurality of second information sub-portions transmitted in different UWB frequency-time portions, wherein each different UWB frequency-time portion is defined as a portion of the UWB frequency-time domain limited by the transmission budget of the UWB channel, wherein the secret distance pulse sequence comprises a plurality of different secret distance pulse sub-sequences transmitted in the different second information sub-portions.

28. The method according to claim 16, wherein the secret distance pulse sequence comprises a plurality of different secret distance pulse sub-sequences transmitted in different UWB frequency-time portions of the UWB channel.

29. A method for distance measurement between a verifier and prover, the method comprising:
sending a challenge message with a challenge pulse sequence from the verifier to the prover;
sending a response message with a response pulse sequence from the prover to the verifier;
determining securely the time-of-arrival of the response message at the verifier based on the method of claim 16; and
measuring the distance between the verifier and the prover based on a verifier time difference between sending out the challenge message from the verifier and the determined time-of-arrival of the response message.

30. The method according to claim 29, further comprising:
determining securely a time-of-arrival of the challenge message at the prover;
determining a prover time difference between the determined time-of-arrival of the challenge message and sending out the response message from the prover;
including prover time information in a first information portion of the response message; and
determining the distance between the verifier and the prover based on the verifier time difference and the prover time difference.
